(19) United States
(12) Patent Application Publication
(10) Pub. No.: US 2022/0258100 A1
(43) Pub. Date: Aug. 18, 2022

(54) PRODUCTS OF MANUFACTURE AND METHODS FOR METHANE CAPTURING USING BIOFILTRATION

(71) Applicant: San Diego State University (SDSU) Foundation, dba San Diego State University Research Foundation, San Diego, CA (US)

(72) Inventors: Marina KALYUZHNAYA, San Diego, CA (US); Richard HAMILTON, San Diego, CA (US)

(21) Appl. No.: 17/627,280

(22) PCT Filed: Jul. 16, 2020
(86) PCT No.: PCT/US20/42309

§ 371 Date: Jan. 14, 2022

Related U.S. Application Data
(60) Provisional application No. 62/874,651, filed on Jul. 16, 2019.

(51) Int. Cl. B01D 53/85; B01D 53/62; B01D 53/72; B01J 19/00; C25B 1/02; C25B 1/24

(52) U.S. Cl. CPC B01D 53/85; B01D 53/62; B01D 53/72; B01J 19/00; B01D 2257/504; C25B 1/24; B01D 2257/7025; B01D 2251/95; C25B 1/02

(57) ABSTRACT

Provided are products of manufacture and methods for the removal of gaseous methane and carbon dioxide, for example, for the removal of environmental or atmospheric or anthropogenically produced gaseous methane and carbon dioxide. Products of manufacture as provided herein comprise living emission abolish filters (LEAFs) for the removal of methane and carbon dioxide, where the “living” component of the “emission abolish filter”, or biofilter, comprises a methane-capturing bioagent, optionally comprising halophilic methanotroph bacterium. Products of manufacture as provided herein are manufactured as arrays, sheets, microfibers and/or microbeads comprising immobilized living, active methane-capturing bioagents, optionally comprising halophilic methanotroph bacterium. In alternative embodiments, the methane-capturing bioagents are enclosed or immobilized in or onto a crystal gel matrix or a nanoshell. Products of manufacture as provided herein can replace gas flares, flare stacks or a gas combustion devices, or are used with a methane scrubbing system.

### RELATED APPLICATIONS

This Patent Convention Treaty (PCT) International Application claims the benefit of priority to U.S. Provisional Application Ser. No. 62/874,651 filed Jul. 16, 2019. The aforementioned application is expressly incorporated herein by reference in its entirety and for all purposes.

### STATEMENT AS TO FEDERALLY SPONSORED RESEARCH

This invention was made with government support under grant no. NSF-CBET award 160503. The government has certain rights in the invention.

### TECHNICAL FIELD

This invention generally relates to biofuels and bacteriology. In alternative embodiments, provided are products of manufacture and kits, and methods, for the removal of gaseous methane and carbon dioxide (CO₂), for example, for the removal of environmental or atmospheric or anthropogenically produced gaseous methane and carbon dioxide (CO₂). In alternative embodiments, products of manufacture as provided herein comprise living emission abolish filters (LEAFs) for the removal of methane and carbon dioxide (CO₂), where the “living” component of the “emission abolish filter”, or biofilter, comprises a methane-capturing bioagent, optionally comprising a halophilic methanotroph bacterium. In alternative embodiments, products of manufacture as provided herein are manufactured or configured as arrays, macro- or nano-particles, microfibers, microtubes, microribbons and/or microbeads, comprising, containing therein or having immobilized therein living, active methane-capturing bioagents, optionally comprising halophilic methanotroph bacterium. In alternative embodiments, the methane-capturing bioagents, optionally comprising halophilic methanotroph bacterium, are enclosed in or immobilized in or onto a crystal gel matrix or a nanoshell. In alternative embodiments, products of manufacture as provided herein are used to replace gas flares, flare stacks or a gas combustion devices, or are used as or in conjunction with a methane scrubbing system in an economic and sustainable fashion.

### BACKGROUND

The consequences of climate change pose significant risks to human health, including reductions of freshwater supplies and food. Global warming transition to increasing emissions of greenhouse gases, including carbon dioxide and methane. Methane is not only a major contributor to climate change, it is also the primary target for near-term climate regulation. Many human-related activities, such as fossil fuel production, agriculture, landfill use, and municipal wastewater generation, are major contributors to global methane emission. The damaging potential of methane is widely recognized, but, so far, gas flares are the only feasible solution and they waste energy and cause air pollution.

Microbial conversion of methane depends on mass transfer of gaseous oxygen and methane, both relatively water-insoluble, to the liquid phase. A number of innovative membrane bioreactors operating at the gas-liquid phase are currently being developed as possible solutions to mass-transfer limitations. However, the bio-composite membrane systems, at the interface of water and gas, are exceptionally costly and thus not applicable to methane mitigation.

### SUMMARY

In alternative embodiments, provided are products of manufacture for the removal of gaseous methane and/or carbon dioxide (CO₂), comprising:

a plurality of methane-capturing bioagents, optionally comprising halophilic methanotroph bacterium, attached to or contained in a plurality of macro- or nano-particles, microfibers, microtubes, microribbons and/or microbeads, or a plurality of methane-capturing bioagents, optionally comprising halophilic methanotroph bacterium, enclosed in or immobilized in or onto a crystal gel matrix or a nanoshell, or equivalent, wherein optionally the plurality of macro- or nano-particles, microfibers, microtubes, microribbons and/or microbeads are arranged or fabricated as an array,

and optionally the bacterium-comprising crystal gel matrix or a nanoshell, or equivalent, are attached to or immobilized on to the plurality of macro- or nano-particles, microfibers, microtubes, microribbons and/or microbeads, or the bacterium-comprising crystal gel matrix or a nanoshell are attached to or immobilized on to a mesh or equivalent supporting structure,

and optionally the gaseous methane and/or carbon dioxide (CO₂) comprises an environmental, atmospheric or anthropogenically produced gaseous methane and/or carbon dioxide (CO₂).

In alternative embodiments of products of manufacture as provided herein, the methane-capturing bioagents, optionally comprising halophilic methanotroph bacterium, are encapsulated or enclosed or immobilized in polymer, a colloidal particle shell, an agar or a gel, or a hydrogel, and optionally the encapsulated structures are immobilized onto the arrays, macro- or nano-particles, microfibers, microtubes, microribbons and/or microbeads.

In alternative embodiments of products of manufacture as provided herein, the halophilic methanotroph cells comprise a bacterium of the genus Methylomicrobium, or comprise M. buryatenses, M. pelagicum and/or M. alcahphilum, or comprise the species/strain M. alcahphilum sp. 20Z or M. alcahphilum 20Z®, and optionally the M. buryatenses comprises species/strain M. buryatenses 5G.

In alternative embodiments of products of manufacture as provided herein, the arrays, macro- or nano-particles, microfibers, microtubes, microribbons and/or microbeads are contained in or fabricated as sheets, mats, meshes, cartridges or any form of secondary or tertiary structure to support the arrays, macro- or nano-particles, microfibers, microtubes, microribbons and/or microbeads, or the immobilized halophilic methanotroph cells.

In alternative embodiments of products of manufacture as provided herein, the arrays, macro- or nano-particles, microfibers, microtubes, microribbons and/or microbeads, or sheets, meshes, mats, cartridges or any form of secondary structure, are fabricated into modular units or cartridges that can be inserted into a superstructure or device, and optionally the modular units or cartridges are fabricated to be exchanged or inserted into a preformed receptacle in or on the superstructure or device, and optionally the modular units or cartridges or equivalent structures are fabricated to have gas input and output openings or orifices, and optionally the superstructure or device comprises a pump, valves and/or pressure gauges controlling the amount of air or gas flow into or through the product of manufacture.

In alternative embodiments, provided are methods for removing a gaseous methane and/or a carbon dioxide (CO₂), comprising: pumping or flowing air or gas comprising the gaseous methane and/or a carbon dioxide into or over or in contact with a product of manufacture as provided herein.

In alternative embodiments of methods as provided herein, the air or gas is derived from a petroleum refinery, a chemical plant, a natural gas processing plant, an oil or gas production site, an oil well, a gas well, an offshore oil or a gas rig, or a landfill, or the air or gas fed into a product of manufacture of any of the preceding claims is the same air or gas that would have been fed in a flare, a flare stack or a gas combustion device.

The details of one or more exemplary embodiments of the invention are set forth in the accompanying drawings and the description below. Other features, objects, and advantages of the invention will be apparent from the description and drawings, and from the claims.

All publications, patents, patent applications cited herein are hereby expressly incorporated by reference for all purposes.

### DESCRIPTION OF DRAWINGS

The drawings set forth herein are illustrative of exemplary embodiments provided herein and are not meant to limit the scope of the invention as encompassed by the claims.

FIG. 1 schematically illustrates an exemplary device as provided herein comprising immobilized methanotrophic bacteria for methane mitigation.

FIG. 2A-B graphically illustrates methane and oxygen consumption data for methanotrophic cells immobilized in nano-shells:

FIG. 2A shows methane consumed in sealed chamber with methane added when needed;

FIG. 2B shows gas consumed in continuous gas flow state.

FIG. 3A-D illustrates images of Scanning Electron Microscopy (SEM) images of the hydrogel bead surface with immobilized cells of Methylomicrobium alcaliphilum 20Z; where the bar (at lower right of each image) is: FIG. 3A is 100 μm; FIG. 3B is 10 μm; FIG. 3C is 10 μm; and, FIG. 3D is 3 μm.

FIG. 4A illustrates a schematic illustration of an exemplary LEAF system as provided herein.

FIG. 4B graphically illustrates the average methane consumption of the exemplary LEAF system for 6 months.

FIG. 4C graphically illustrates the amount of methane consumed by an individual unit of the exemplary LEAF system; methane consumption is displayed as percentage of total methane supplied (1% CH₄ in gas flow).

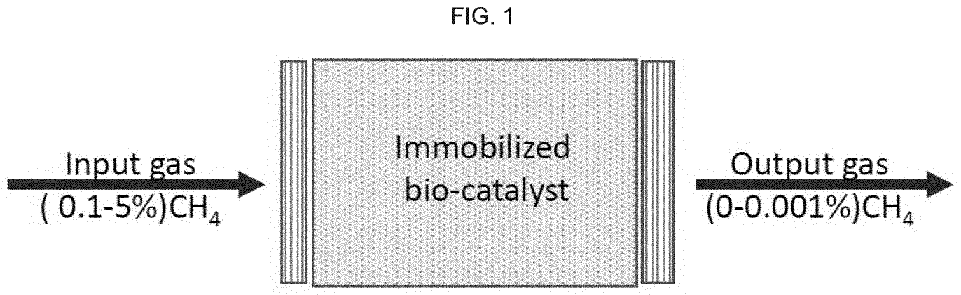

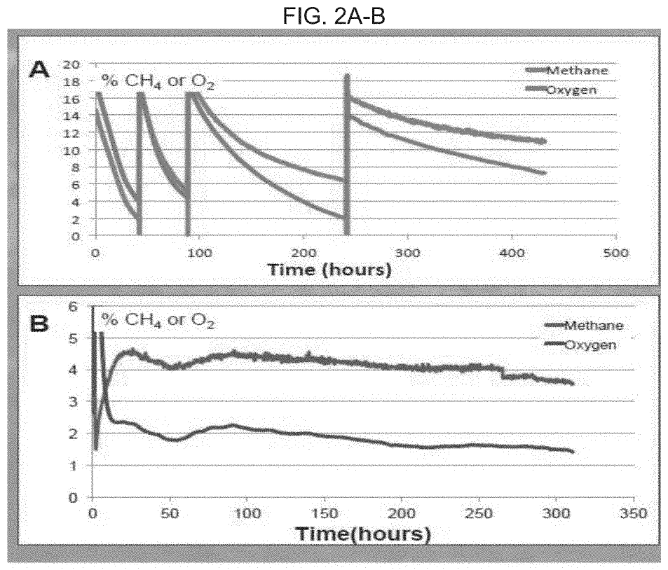

Like reference symbols in the various drawings indicate like elements.

### DETAILED DESCRIPTION

In alternative embodiments, provided are products of manufacture and kits, and methods, for the removal of gaseous environmental, atmospheric or anthropogenically produced gaseous methane and/or carbon dioxide (CO₂). In alternative embodiments, products of manufacture as provided herein comprise or are configured as living emission abolish filters (LEAFs) for the removal of gaseous methane and carbon dioxide (CO₂), where the “living” component of the “emission abolish filter”, or biofilter, comprises one or a plurality of methane-capturing bioagents, optionally comprising halophilic methanotrophs.

In alternative embodiments, LEAF systems as provided herein are based on the unique ability of methane-capturing bioagents, optionally comprising halophilic methanotrophs, to sustain dryness by capturing and producing water from methane. LEAFs are a transformative solution for microbial methane utilization, since the immobilization of active cells on/into LEAF matrix reduces limitation of gas-to-liquid transfer and improves methane capturing.

In alternative embodiments, products of manufacture as provided herein are manufactured or configured as arrays, macro- or nano-particles, microfibers, microtubes, microribbons and/or microbeads, where alternatively the macro- or nano-particles, microfibers, microtubes, microribbons and/or microbeads are arranged in arrays. In alternative embodiments, living, active methane-capturing bioagents, optionally comprising halophilic methanotroph cells, are contained in and/or on or are immobilized (directly or indirectly, covalently or non-covalently) in and/or on the arrays, macro- or nano-particles, microfibers, microtubes, microribbons and/or microbeads or nanobeads or equivalents.

In alternative embodiments, the methane-capturing bioagents (methanotrophic bacteria, membranes, or enzymes, including for example, halophilic methanotrophs) are enclosed in or immobilized in or onto a crystal gel matrix, a nanoshell, nanoparticle or equivalent. In alternative embodiments, the methane-capturing bioagents (e.g., halophilic methanotrophs) are encapsulated or enclosed or immobilized in and/or on a polymer, a colloidal particle shell, an agar or a gel such as a hydrogel or equivalents. In alternative embodiments, the structures into which the methane-capturing bioagents are encapsulated (e.g., nanoshells or nanoparticles) are immobilized onto the arrays, macro- or nano-particles, microfibers, microtubes, microribbons and/or microbeads, or equivalents.

In alternative embodiments, the nanoshells are oxide nanoshells such as hollow silica nanoshells, or are metal nanoshells such as gold and silver nanoshells. In alternative embodiments, the nanoparticles comprise CdSe nanoparticles coated with CdS or ZnTe and CdTe nanoparticles coated with CdSe. In alternative embodiments, gold nanoshells (AuNShs) comprise a silica core coated by a thin gold metallic shell.

In alternative embodiments, the microparticles or nanoparticles comprise or are manufactured as plasmonic particles, and the microparticles or nanoparticles can comprise or have an exterior coating comprising: graphene, graphene oxide, reduced graphene oxide, polyethylene glycol (PEG), silica, silica-oxide, polyvinylpyrrolidone, polystyrene, silica, silver, polyvinylpyrrolidone (PVP), cetyl trimethylammonium bromide (CTAB), citrate, lipoic acid, a short chain polyethylenimine (PI), a branched polyethylenimine, reduced graphene oxide, a protein, a peptide, a glycosaminoglycan, or any combination thereof. The nanoparticles, crystal gel matrices or nanoshells can be made by any method, for example, as described in U.S. Pat. No. 9,991,458.

In alternative embodiments, the arrays, macro- or nano-particles, microfibers, microtubes, microribbons and/or microbeads are themselves contained in or fabricated as sheets, mats, meshes, cartridges or any form of secondary or tertiary structure to support the arrays, macro- or nano-particles, microfibers, microtubes, microribbons and/or microbeads, or the immobilized halophilic methanotroph cells, or LEAFs as provided herein.

In alternative embodiments, the arrays, macro- or nano-particles, microfibers, microtubes, microribbons and/or microbeads, or sheets, meshes, mats, cartridges or any form of secondary structure, are fabricated into modular units or cartridges that can be inserted into a superstructure or device, for example, the modular units or cartridges can be fabricated to be exchanged or inserted into a preformed receptacle in or on the superstructure or device, for example to replace an older unit with a newer, fresh unit or cartridge. In alternative embodiments the modular units or cartridges or equivalent structures are fabricated to have gas input and output openings or orifices; for example, gases such as methane-comprising air are fed into the modular unit, cartridge or equivalent structure under pressure such that the air or gas passes through the modular unit, cartridge or equivalent structure and can interact with exemplary LEAFs within the modular unit, cartridge or equivalent structure.

In alternative embodiments, the arrays, macro- or nano-particles, microfibers, microtubes, microribbons and/or microbeads configured as exemplary LEAFs of immobilized, active methane-capturing bioagents, optionally comprising halophilic methanotroph cells, are a cheap, simple, scalable, cartridge-like system for capturing methane.

In alternative embodiments, methane-capturing bioagents such as halophilic methanotroph cells are used in products of manufacture, and they can comprise bacteria of the genus Methylomicrobium (also known as Methylotuvimicrobium, Methylobacter), for example, can comprise M. buryatenses, M. pelagicum and/or M. alcahphilum, and optionally the M. alcahphilum can comprise the species/strain M. alcahphilum sp. 20Z or M. alcahphilum 20Z®, and optionally the M. buryatenses can comprise species/strain M. buryatenses 5G.

### Kits

Provided are kits comprising products of manufacture as provided herein, including products of manufacture fully assembled as arrays, sheets, microfibers and/or microbeads or particles configured as exemplary LEAFs of immobilized, active methane-capturing bioagents, optionally comprising halophilic methanotroph cells, or comprising sheets, mats, cartridges or any form of secondary or tertiary structure to support the arrays, particles, sheets. microfibers and/or microbeads, or immobilized methane-capturing bioagents, optionally comprising halophilic methanotroph cells, wherein the sheets, mats, cartridges and the like can be further fabricated into tertiary structures, such as modular units that can be easily replaced or exchanged on a superstructure or device.

Any of the above aspects and embodiments can be combined with any other aspect or embodiment as disclosed here in the Summary, Figures and/or Detailed Description sections.

As used in this specification and the claims, the singular forms “a,” “an” and “the” include plural referents unless the context clearly dictates otherwise.

Unless specifically stated or obvious from context, as used herein, the term “or” is understood to be inclusive and covers both “or” and “and”.

Unless specifically stated or obvious from context, as used herein, the term “about” is understood as within a range of normal tolerance in the art, for example within 2 standard deviations of the mean. About (use of the term “about”) can be understood as within 20%, 19%, 18%, 17%, 16%, 15%, 14%, 13%, 12% 11%, 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Unless specifically stated or obvious from context, as used herein, the terms “substantially all”, “substantially most of”, “substantially all of” or “majority of” encompass at least about 90%, 95%, 97%, 98%, 99% or 99.5%, or more of a referenced amount of a composition.

The entirety of each patent, patent application, publication and document referenced herein hereby is incorporated by reference. Citation of the above patents, patent applications, publications and documents is not an admission that any of the foregoing is pertinent prior art, nor does it constitute any admission as to the contents or date of these publications or documents. Incorporation by reference of these documents, standing alone, should not be construed as an assertion or admission that any portion of the contents of any document is considered to be essential material for satisfying any national or regional statutory disclosure requirement for patent applications. Notwithstanding, the right is reserved for relying upon any of such documents, where appropriate, for providing material deemed essential to the claimed subject matter by an examining authority or court.

Modifications may be made to the foregoing without departing from the basic aspects of the invention. Although the invention has been described in substantial detail with reference to one or more specific embodiments, those of ordinary skill in the art will recognize that changes may be made to the embodiments specifically disclosed in this application, and yet these modifications and improvements are within the scope and spirit of the invention. The invention illustratively described herein suitably may be practiced in the absence of any element(s) not specifically disclosed herein. Thus, for example, in each instance herein any of the terms “comprising”, “consisting essentially of”, and “consisting of” may be replaced with either of the other two terms. Thus, the terms and expressions which have been employed are used as terms of description and not of limitation, equivalents of the features shown and described, or portions thereof, are not excluded, and it is recognized that various modifications are possible within the scope of the invention. Embodiments of the invention are set forth in the following claims.

### EXAMPLES

### Example 1: Fabrication of Products of Manufacture

Microbial methane utilization relies on a number of key microelements, e.g., copper, iron, calcium, tungsten and Rare Earth Elements (REE). We investigated the steady-state growth of Methylomicrobium alcahphilum 20Z® in media containing calcium (Ca) or lanthanum (La, a REE element), with or without copper, with or without tungsten. The data were used to optimize medium for preparing methane-capturing agents for immobilization. See, e.g., Akberdin I. R., et al. (2018b) Rare earth elements alter redox balance in Methylomicrobium alcahphilum 20Z®; Front Microbiol. 9, 2735; Akberdin I. R., et al. (2018) Methane utilization in Methylomicrobium alcahphilum 20Z®: a systems approach; Sci. Rep. 8:2512; Collins D A, et al. (2018) Navigating methane metabolism: enzymes, compartments, and networks; Methods Enzymol. 613:349-383.

Different strategies for encapsulation/immobilization of methanotrophic cells were tested. We demonstrated that immobilization of methanotrophic bacteria on/into a crystal gel matrix (nano shells) provides the most efficient environment for methane oxidation activity. We demonstrated that nano shells can preserve high activity of methane oxidation for 4-5 weeks, while other approaches such as immobilization on cellulase/paper or alginate encapsulation led to a dramatic drop in methane consumption over 2-5 days.

### LEAFs: “Living” Filters for Greenhouse Gas Capturing:

Cells of methanotrophic bacteria were grown in a BIOFLOW™ methane-bioreactor until high cell density. Cells were collected by centrifugation of filtration, re-suspended in (or washed with) basal mineral medium containing a 3×-concentration of all key nutrients (KNO₃, MgSO₄ and trace solution) and loaded on/into immobilization matrix: ashless GR41 paper (Whatman), nilone membranes or mixed with hydro-gel beads. The prepared immobilized bioagents were tested for methane-consumption and cell viability for weeks.

### System Performance and Stability

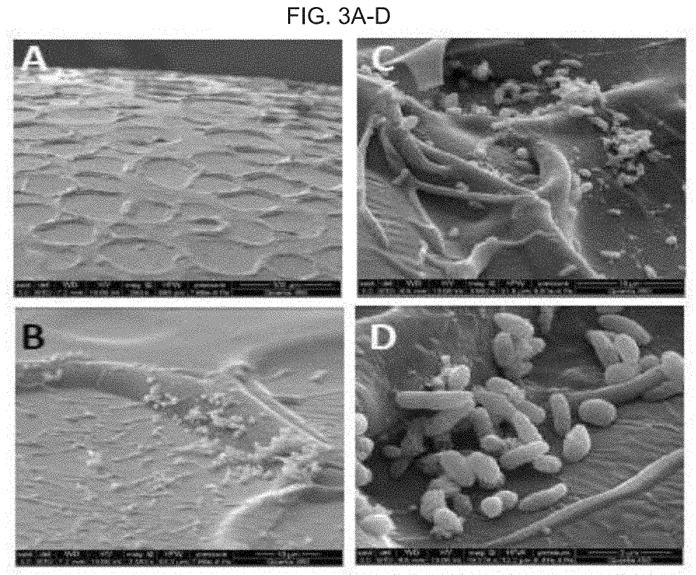

In alternative embodiments, the overall impact of exemplary LEAF technology as provided herein depends on the system's stability over prolonged periods of time. Immobilized cells were tested in a set of gas washing bottle (i.e. mini-unit) with a standard taper 34/28 top joint. A series of 5 units were assembled. Each mini-unit was filled with 100 ml of 2× mineral media, cells (2-5 g WCW) and 7 gram (g) beads. Beads saturation was performed with stirring to assure even immobilization (coverage) of cells on the surface. The samples of beads were investigated using Scanning Electron Microscopy (SEM), as shown in FIG. 3A. The protocol applied here resulted in 5-10% surface coverage.

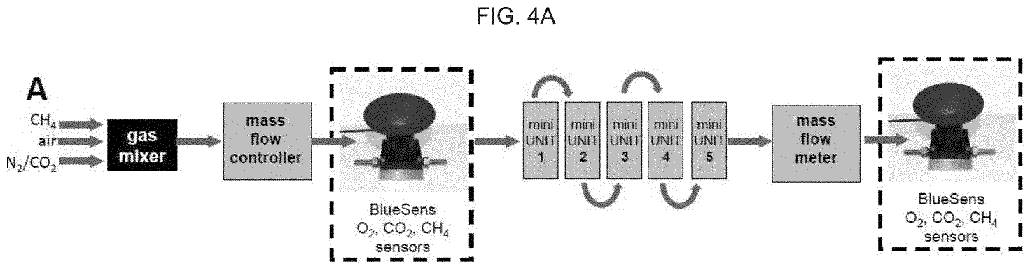

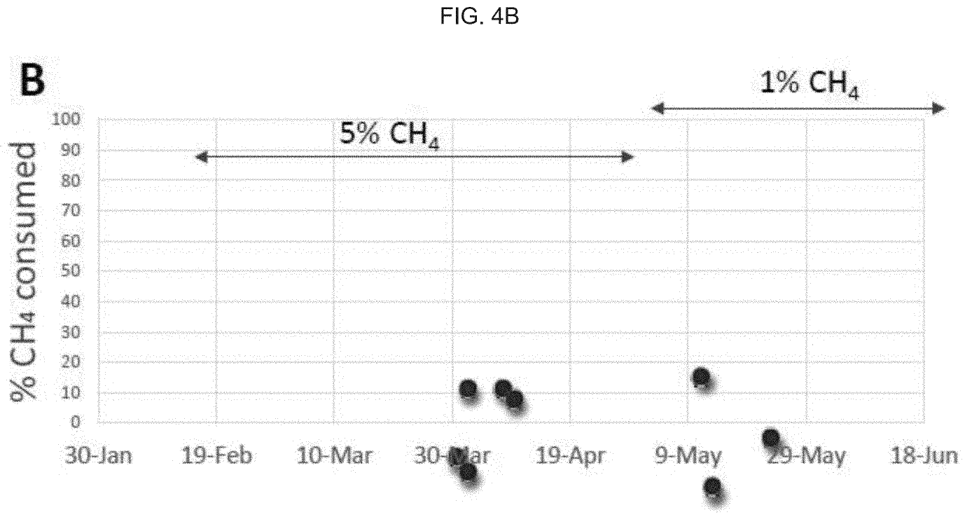

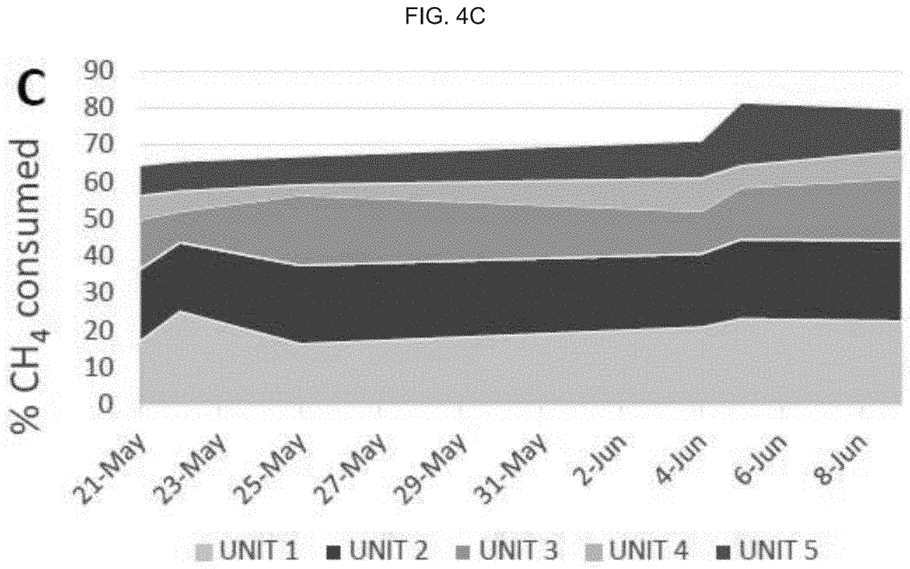

The final trial system set up included a gas mixer to achieve desired concentration of input gases (CH₄, Air, CO₂), mass flow controllers and meter to set and/or collect gas flow parameters, and a set of sensors for collecting simultaneous measurements of methane, CO₂ and oxygen. This exemplary system is illustrated in FIG. 4A-B. After the initial set-up the methane consumption per unit typically increased by 21±5% during the first month. The consumption of methane by all five units connected in tandem fluctuated from 54% to 94% and depended on the concentration of methane in the gas stream, and represented on average 53±19% with 5% CH₄ and 77±9% with CH₄ supplied as 1% of the gas stream (flow rate of 100 SLPH/m²), as illustrated in FIG. 3C-D. Decrease in methane consumption was observed after four months of continuous operation. On average, each unit displayed 83% of the original consumption. The data demonstrate the long-term stability of the system.

FIG. 3A-D illustrates images of Scanning Electron Microscopy (SEM) images of the hydrogel bead surface with immobilized cells of Methylomicrobium alcaliphilum 20Z; where the bar (at lower right of each image) is: FIG. 3A is 100 μm; FIG. 3B is 10 μm; FIG. 3C is 10 μm; and, FIG. 3D is 3 μm.

After immobilization, beads with immobilized cells were fixed for 1 hour with 1% glutaraldehyde, 0.5% osmium tetroxide in phosphate buffered saline (PBS, pH 7.5) solution and then dehydrated through a graded 50-100% ethanol series. Dehydrated samples were dried through carbon dioxide critical point drying followed by a single 6 nm platinum sputter coating. Samples were imaged on an FEI Quanta FEG 450 at 10 kV accelerating voltage at a working distance of 10 mm.

FIG. 4A illustrates a schematic illustration of an exemplary LEAF system as provided herein. FIG. 4B graphically illustrates the average methane consumption of the exemplary LEAF system for 6 months. FIG. 4C graphically illustrates the amount of methane consumed by an individual unit of the exemplary LEAF system. Methane consumption is displayed as percentage of total methane supplied (1% CH₄ in gas flow).

A number of embodiments of the invention have been described. Nevertheless, it can be understood that various modifications may be made without departing from the spirit and scope of the invention. Accordingly, other embodiments are within the scope of the following claims.

1: A product of manufacture for the removal of gaseous methane and/or carbon dioxide (CO2), comprising:
a plurality of methane-capturing bioagents attached to or contained in a plurality of macro- or nano-particles, microfibers, microtubes, microribbons and/or microbeads, or enclosed in or immobilized in or onto a crystal gel matrix or a nanoshell, or equivalent.

2: The product of manufacture of claim 1, wherein the methane-capturing bioagents are encapsulated or enclosed or immobilized in polymer, a colloidal particle shell, an agar or a gel, or a hydrogel, or
are immobilized onto the arrays or sheets, macro- or nano-particles, microfibers, microtubes, microribbons and/or microbeads.

3: The product of manufacture of claim 1 where the halophilic methanotroph cells comprise a bacterium of the genus Methylomicrobium.

4: The product of manufacture of claim 1, wherein the arrays, sheets, macro- or nano-particles, microfibers, microtubes, microribbons and/or microbeads are contained in or fabricated as sheets, mats, meshes, cartridges or any form of secondary or tertiary structure to support the arrays, macro- or nano-particles, microfibers, microtubes, microribbons and/or microbeads, or the immobilized halophilic methanotroph cells.

5: The product of manufacture of claim 1, wherein the arrays, macro- or nano-particles, microfibers, microtubes, microribbons and/or microbeads, or sheets, meshes, mats, cartridges or any form of secondary structure, are fabricated into modular units or cartridges that can be inserted into a superstructure or device.

6: A method for removing a gaseous methane and/or a carbon dioxide (CO2), comprising: pumping or flowing air or gas comprising the gaseous methane and/or a carbon dioxide into or over or in contact with a product of manufacture of claim 1.

7: The method of claim 6, wherein the air or gas is derived from a petroleum refinery, a chemical plant, a natural gas processing plant, an oil or gas production site, an oil well, a gas well, an offshore oil or a gas rig, or a landfill, or the air or gas fed into the product of manufacture is the same air or gas that would have been fed in a flare, a flare stack or a gas combustion device.

8: The method of claim 1, wherein the plurality of methane-capturing bioagents comprise halophilic methanotroph bacterium.

9: The method of claim 1, wherein the plurality of macro- or nano-particles, microfibers, microtubes, microribbons and/or microbeads are arranged or fabricated as an array or a sheet.

10: The method of claim 1, wherein the bacterium-comprising crystal gel matrix or a nanoshell or equivalent, are attached to or immobilized on to the plurality of macro- or nano-particles, microfibers, microtubes, microribbons and/or microbeads, or the bacterium-comprising crystal gel matrix or a nanoshell or equivalent, are attached to or immobilized on to a mesh or equivalent supporting structure.

11: The method of claim 1, wherein the gaseous methane and/or carbon dioxide (CO₂) comprises an environmental, atmospheric or anthropogenically produced gaseous methane and/or carbon dioxide (CO₂).

12: The product of manufacture of claim 6, wherein the modular units or cartridges are fabricated to be exchanged or inserted into a preformed receptacle in or on the superstructure or device.

13: The product of manufacture of claim 6, wherein the modular units or cartridges or equivalent structures are fabricated to have gas input and output openings or orifices.

14: The product of manufacture of claim 6, wherein the superstructure or device comprises a pump, valves and/or pressure gauges controlling the amount of air or gas flow into or through the product of manufacture.

15: The product of manufacture of claim 1, where the halophilic genus Methylomicrobium comprise M. buryatenses, M. pelagicum and/or M. alcaliphilum, or comprise the species/strain M. alcaliphilum sp. 20Z or M. alcaliphilum 20ZR.

16: The method of claim 15, wherein the M. buryatenses comprises species/strain M. buryatenses 5G.
